(19) United States
(12) Patent Application Publication
(10) Pub. No.: US 2011/0266912 A1
(43) Pub. Date: Nov. 3, 2011

(54) ROTATING ELECTRIC MACHINE WITH A STATOR WINDING COMPRISING A PLURALITY OF COILS AND METHOD FOR MANUFACTURING SAME

(75) Inventor: Charles SMADJA, Toulouse (FR)

(73) Assignee: ALSTOM HYDRO FRANCE, Levallois Perret (FR)

(21) Appl. No.: 13/095,382

(22) Filed: Apr. 27, 2011

Related U.S. Application Data
(60) Provisional application No. 61/330,087, filed on Apr. 30, 2010.

(51) Int. Cl. H02K 3/28; H02K 15/00

(52) U.S. Cl. 310/208; 29/596

(57) ABSTRACT

A rotating electric machine is provided and includes a rotor rotating around an axis, and a stator concentrically surrounding the rotor, the stator being equipped with a stator winding, which includes a plurality of coils. Each of the coils is wound in a series of adjacent single coils around a respective series of adjacent teeth distributed along the inner circumference of a laminated stator core and extending in axial direction. All of the single coils of each coil are wound in an uninterrupted fashion with one continuous cable.

### CROSS REFERENCE TO RELATED APPLICATION

This application claims the benefit of U.S. Provisional Application No. 61/330,087, filed Apr. 30, 2010, the entire contents of all of which is incorporated by reference as if fully set forth.

### FIELD OF INVENTION

The present invention relates to electric machines, specifically it refers to rotating electric machines. It refers further to a method for manufacturing a coil for such a rotating electric machine.

### BACKGROUND

Electrical machines with more than three phases are known, and are used in particular for large synchronous drives and for submarine applications. A special problem of such machines is the manufacturing and mounting of the respective stator winding. Often, stator coils are designed and manufactured using a known tooth-wound fractional winding arrangement.

In conventional tooth-wound fractional windings the different phases are interlaced, which means that coils belonging to consecutive phases embrace adjacent teeth. The interlaced coils result in crossings of conductors in the end-windings, and the tooth-wound coils have to be connected one to the other.

### SUMMARY

The present disclosure is directed to a rotating electric machine is provided and includes a rotor rotating around an axis, and a stator concentrically surrounding the 1464537-1 rotor, the stator being equipped with a stator winding, which includes a plurality of coils. Each of the coils is wound in a series of adjacent single coils around a respective series of adjacent teeth distributed along the inner circumference of a laminated stator core and extending in axial direction. All of the single coils of each coil are wound in an uninterrupted fashion with one continuous cable.

In another aspect, the disclosure is directed to a method for manufacturing a coil for a rotating electric machine including the steps of:
a) providing a flat cable using a predetermined number of copper strands with rectangular cross section;
b) insulating the cable by wrapping around an insulating tape;
c) winding with said cable a first single coil on a mandrel, such that said first single coil fits on a tooth of the stator of the rotating electric machine;
d) detaching the first single coil from the mandrel and turning it around without cutting the cable;
e) winding with said cable a second single coil on a mandrel, such that said second single coil fits on a tooth of the stator of the rotating electric machine;
f) detaching the second single coil from the mandrel, turning it around without cutting the cable and placing it aside the first single coil as the coils are arranged and interconnected in the stator; and
g) repeating steps (e) and (f), until all single coils of the coil are wound and arranged to build said coil.

### BRIEF DESCRIPTION OF THE DRAWINGS

The present invention is now to be explained more closely by means of different embodiments and with reference to the attached drawings.

FIG. 1 shows in a perspective view a stator coil comprising four single coils according to an embodiment of the invention;

FIG. 2 shows the coil of FIG. 1 in a top view;

FIG. 3 shows the coil of FIG. 1 in a side view;

FIG. 4 shows the principle of manufacturing the cable of the coil according to FIG. 1; and

FIG. 5 shows an embodiment of a machine according to the invention with a mounted stator coil.

### DETAILED DESCRIPTION OF THE PREFERRED EMBODIMENTS

### Introduction to the Embodiments

It is therefore an object of the present invention to provide a rotating electric machine which uses a simplified stator winding design and manufacturing process and to disclose a method for manufacturing the necessary stator coils.

This object is obtained by a rotating electric machine according to claim 1 and a method according to claim 8.

The rotating electric machine according to the invention comprises a rotor rotating around an axis, and a stator concentrically surrounding said rotor, said stator being equipped with a stator winding, which comprises a plurality of coils. Each of said coils is wound in a series of adjacent single coils around a respective series of adjacent teeth distributed along the inner circumference of a laminated stator core and extending in axial direction, whereby all single coils of each coil are wound in an uninterrupted fashion with one continuous cable.

The invention thus provides a design and a manufacturing process to wind several consecutive teeth using a unique generator coil. The risk of short-circuit induced by a manufacturing defect is greatly reduced. The numerous connections of coils are avoided, reducing failure risks e.g. by corrosion, and enabling simplification of the end-winding holding structure. The generator end-winding design is thus highly simplified compared to a conventional arrangement leading in general to complicated assembly processes and a sophisticated tightening structure. As part of the invention the phases are not interlaced but made up of tooth-wound coils that are located on adjacent teeth. Therefore the stator conductor is not interrupted from one tooth to the next one belonging to the same stator phase.

According to one embodiment of the invention said cable is made from several, preferably identical, copper strands.

Preferably, the copper strands of each cable have a rectangular cross section and lie parallel in the cable without being transposed, such that the thickness of the cable is almost identical to a thickness of a single copper strand.

According to another embodiment of the invention the cable is formed as a flat cable and wound within the single coils, such that adjacent windings abut with their flat sides.

According to another embodiment of the invention the single coils of each coil each have the same number of turns.

According to another embodiment of the invention adjacent single coils of each coil are interconnected by an interconnection in the form of an arched section of the cable outside of the teeth, and within each coil the interconnections are placed on alternating sides of the coil.

According to just another embodiment of the invention the machine has several, preferably 3, 5 or 7, phases, and each of said plurality of coils is assigned to one of said phases.

The method for manufacturing a coil for a rotating electric machine according to the invention includes the steps of:
h) providing a flat cable using a predetermined number of copper strands with rectangular cross section;
i) insulating the cable by wrapping around an insulating tape;
j) winding with said cable a first single coil on a mandrel, such that said first single coil fits on a tooth of the stator of the rotating electric machine;
k) detaching the first single coil from the mandrel and turning it around without cutting the cable;
l) winding with said cable a second single coil on a mandrel, such that said second single coil fits on a tooth of the stator of the rotating electric machine;
m) detaching the second single coil from the mandrel, turning it around without cutting the cable and placing it aside the first single coil as the coils are arranged and interconnected in the stator;
n) repeating steps (e) and (f), until all single coils of the coil are wound and arranged to build said coil.

According to an embodiment of the inventive method the coil is impregnated after being wound.

According to another embodiment the coil is impregnated before being inserted into the slots of the stator, and the interconnections between adjacent single coils of the coil are prevented from being impregnated at that time.

According to another embodiment the coil is impregnated with all other coils of the machine after being inserted into the slots of the stator in a global impregnation process.

### DETAILED DESCRIPTION

The present invention relates generally to rotating electric machines, and more specifically, but not exclusively, to synchronous generators using a number of electrical phases that can be three or more, preferably 5 or 7, but possibly any desired value.

A simplified stator winding and manufacturing process for multiple phase electrical machines is proposed. The generator end-winding design is highly simplified compared to a conventional arrangement leading in general to complicated assembly processes and a sophisticated tightening structure.

FIG. 5 shows a part of rotating electric machine 10 according to an embodiment of the invention. The rotating electric machine 10 comprises a central rotor 11, which rotates around a machine axis, not shown. The rotor 11, which for example is equipped with permanent magnets, is concentrically surrounded by a stator 12. Stator 12 has a laminated stator core 13, which is provided with a plurality of axially extending teeth 14 at its inner circumference. The teeth 14 are separated by respective slots 15, which receive a stator winding 16 with stator coils wound from a cable 17.

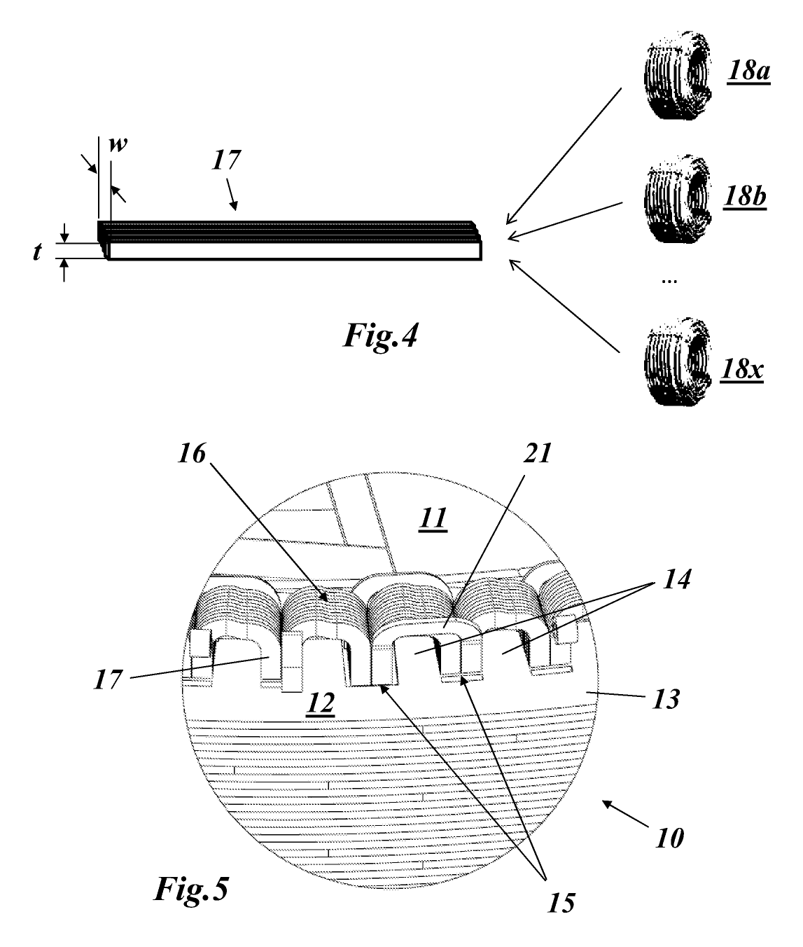

As can be seen in FIG. 4, each cable 17 is made from several copper strands 18a, 18b, . . . , 18x. According to the preferred embodiment, the copper strands 18a, 18b, . . . , 18x are not transposed and lie parallel to each other in the cable 17. Alternatively, the cable 17 can be transposed, e.g. a cable of the Rutherford-type.

The cable is manufactured using n strands of copper 18a, 18b, . . . , 18x. According to the preferred embodiment, the cable is constituted of a single layer of strands of rectangular cross section. It is a matter of design optimization to keep the thickness of the cable 17 small enough to avoid unacceptable eddy currents from slot stray fields.

Still according to the preferred embodiment the width of the (preferably identical) strands 18a, 18b, . . . , 18x is equal to the thickness t of the cable 17 and the strand thickness, i.e. its smallest lateral dimension is equal to the cable width w divided by n. For example a 4×15 mm² cable is preferably made of 6 strands 4×2.5 mm² rather than from 2 strands of 4×7.5 mm². Then the cable 17 will have a good bending behavior at coil corners. The single layer cable 17 with the smaller lateral dimension of the strand along the width w of the cable 17 provides flexibility in two key directions for the manufacturing process.

Each cable 17 is insulated with insulating tape, generally by using an automatic robot to apply the tape around the cable 17. The tape contributes to keeping the cable geometry at the sharp bends.

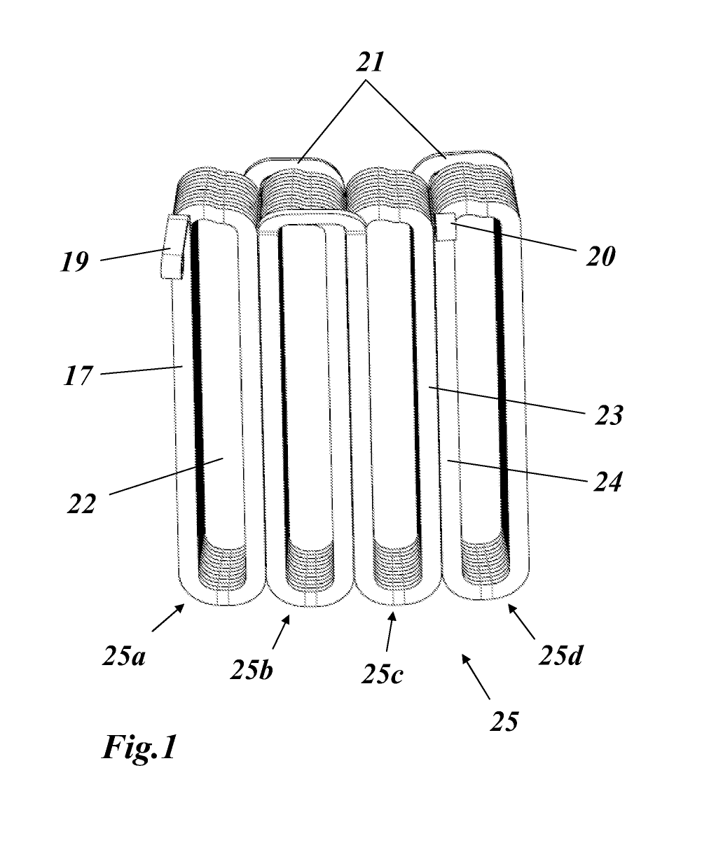

FIGS. 1 to 3 show one embodiment of the coil 25 of the invention. The stator winding 16 comprises a plurality of such coils 25, whereby each coil 25 is assigned to one of the phases of the winding. Each coil 25 is made from a single continuous cable 17, which is wound, such that adjacent windings abut with their flat sides. Each coil 25 comprises and consists of a plurality of (four in FIG. 1-3) single coils 25a-d, which are wound from said single continuous cable 17 in a series around a respective series of adjacent teeth 14 (see FIG. 5). Each coil 25 has two end connections 19 and 20. Each single coil 25a-d has an inner space 22 to receive a tooth 14 of the laminated stator core 13. The adjacent coil sections 23, 24 of adjacent single coils 25c, 25d are inserted into a respective slot 15 of the laminated stator core 13. When a single coil or tooth has been completely wound, the winding process continues with the same cable and the next single coil or tooth. No interruption of the cable is required. The same cable is used to wind the next stator tooth. The coil 25 as a whole is a single component made of a single piece of cable 17.

The assembly process of the coils 25 in the stator 12 is therefore much simpler than in the prior art. In case of a globally resin-impregnated stator 12, each coil 25 (one per phase) needs to be inserted in the stator 12 around the teeth 14, and then the stator 12 with its coils 25 is globally impregnated.

If global stator impregnation cannot be used (for a very large stator diameter for example), each coil 25 (one per phase) is impregnated and cured separately, and then assembled in the stator. In this case the impregnation process may have to be adapted to keep a sufficient flexibility of the section of cable 17, which bridges two consecutive single coils 25a-d as an interconnection 21.

To manufacture the coil 25 according to FIGS. 1 to 3 the cable 17 is shaped to fit with a first single coil 25a on a stator tooth 14 with its inner space 22, using a mandrel. The first single coil 25a is then turned by 90° without cutting the cable 17. It stays on the winding machine below the mandrel for the next single coils to be wound. During this operation the cable 17 is bent locally on its wide edge (easy bending direction for the cable17) at the single coil interconnection 21 going from one tooth 14 to the next. This interconnection 21 may have to be slightly longer to ease the bending.

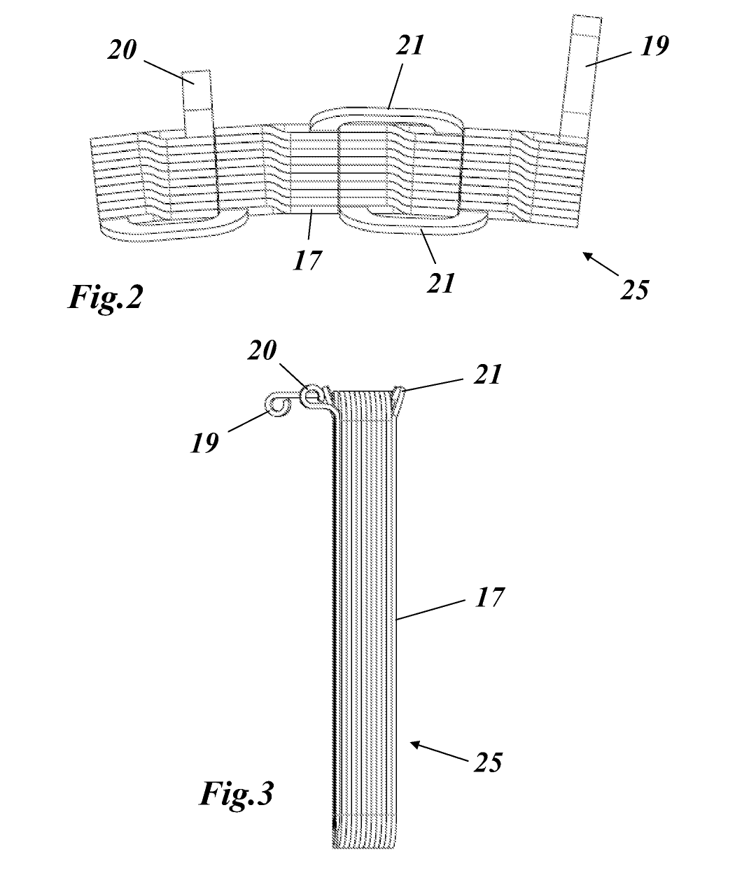

The next operation is to wind the second single coil 25b. After being wound on the mandrel the second single coil 25b is turned by 90° and placed aside the first one in a configuration as it will be in the stator 12 (FIG. 5). At the same time the first interconnection 21 is folded back to its exact final shape as shown in FIGS. 1 and 2.

Repeating these steps all four single coils 25a-d of the coil 25 of FIG. 1 are manufactured on the mandrel and put into the series relation shown in FIG. 1 by using only one continuous cable 17. However, the coil may have more than four single coils, if required.

The winding process takes benefit of the flexibility in both directions of the single strand layer cable 17. The implementation of the sets of single coils into the stator yoke requires that the interconnections 21 between the single coils keep a reasonable flexibility, which is the case when global impregnation is performed after coil insertion into the stator slots 15. If the coils are impregnated and cured before insertion into the stator slots 15 then it is necessary to prevent impregnation or to at least prevent curing of the interconnection 21, which will have to be done after insertion of the cured set of single coils 25a-d into the stator slots 15.

The main advantages of the invention are:

No Roebelization is required

There is no complicated generator end-winding

There are no intermediate welds between coils after assembly of coils in the slots

There are no crossings of conductors belonging to different phases of the machine

The manufacturing and assembly process is simplified

### LIST OF REFERENCE NUMERALS

10 electric rotating machine
11 rotor
12 stator
13 laminated stator core
14 tooth
15 slot
16 stator winding
17 cable
18a,18b,18x copper strand
19, 20 connection
21 interconnection
22 inner space
23, 24 coil section
25 coil
25a-d single coil
t thickness (cable)
w width (cable)

What is claimed is:

1. Rotating electric machine (10), comprising a rotor (11) rotating around an axis, and a stator (12) concentrically surrounding said rotor (11), said stator (12) being equipped with a stator winding (16), which comprises a plurality of coils (25), each of said coils (25) is wound in a series of adjacent single coils (25a-d) around a respective series of adjacent teeth (14) distributed along an inner circumference of a laminated stator core (13) and extending in axial direction, all of the single coils (25a-d) of each coil (25) are wound in an uninterrupted fashion with one continuous cable (17).

2. Rotating electric machine according to claim 1, wherein said cable (17) is made from several copper strands (18a, 18b, . . . , 18x).

3. Rotating electric machine according to claim 2, wherein the copper strands (18a, 18b, . . . , 18x) of each cable (17) have a rectangular cross section and lie parallel in the cable without being transposed, such that the thickness of the cable (17) is almost identical to a thickness of a single copper strand (18a, 18b, . . . , 18x).

4. Rotating electric machine according to claim 1, wherein the cable (17) is formed as a flat cable and wound within the single coils (25a-d), such that adjacent windings have flat sides that abut each other.

5. Rotating electric machine according to claim 1, wherein the single coils (25a-d) of each coil (25) each have the same number of turns.

6. Rotating electric machine according to claim 1, wherein adjacent single coils (25a-d) of each coil (25) are interconnected by an interconnection (21) in the form of an arched section of the cable (17) outside of the teeth (14), and within each coil (25) the interconnections (21) are placed on alternating sides of the coil (25).

7. Rotating electric machine according to claim 1, wherein the machine has 3, 5 or 7 phases and each of said plurality of coils (25) is assigned to one of said phases.

8. Rotating electric machine (10) of claim 1, wherein the machine is a multi-phase synchronous generator.

9. Method for manufacturing a coil (25) for a rotating electric machine (10) comprising the steps of:
a) providing a flat cable (17) using a predetermined number of copper strands (18a, 18b, . . . , 18x) with rectangular cross section;
b) insulating the cable (17) by wrapping around an insulating tape;
c) winding with said cable (17) a first single coil (25a) on a mandrel, such that said first single coil (25a) fits on a tooth (14) of the stator (11) of the rotating electric machine (10);
d) detaching the first single coil (25a) from the mandrel and turning it around without cutting the cable (17);
e) winding with said cable (17) a second single coil (25b) on a mandrel, such that said second single coil (25b) fits on a tooth (14) of the stator (11) of the rotating electric machine (10);
f) detaching the second single coil (25b) from the mandrel, turning it around without cutting the cable (17) and placing it aside the first single coil (25a) as the coils are arranged and interconnected in the stator (11); and
g) repeating steps (e) and (f), until all of the single coils (25a-d) of the coil (25) are wound and arranged to build said coil (25).

10. Method according to claim 9, wherein the coil (25) is impregnated after being wound.

11. Method according to claim 9, wherein the coil (25) is impregnated before being inserted into the slots (15) of the stator (11), and the interconnections (21) between adjacent single coils (25a-d) of the coil are prevented from being impregnated at that time.

12. Method according to claim 9, wherein the coil (25) is impregnated with all other coils of the machine after being inserted into the slots (15) of the stator (11) in a global impregnation process.
